(19) United States
(12) Patent Application Publication
(10) Pub. No.: US 2026/0243472 A1
(43) Pub. Date: Aug. 20, 2026

(54) CRYOGENIC COOLING SYSTEM WITH ACTIVE HEAT EXCHANGER

(71) Applicant: Bluefors Oy, Helsinki (FI)

(72) Inventors: Lief ROSCHIER, Helsinki (FI); Benjamin ALLDRITT, Helsinki (FI)

(73) Assignee: Bluefors Oy, Helsinki (FI)

(21) Appl. No.: 19/164,610

(22) PCT Filed: Mar. 21, 2024
(86) PCT No.: PCT/FI2024/050139

§ 371 Date: Sep. 12, 2025

(30) Foreign Application Priority Data
Mar. 24, 2023 (EP) 23163965.9

(51) Int. Cl. F25B 9/10; F25D 19/00

(52) U.S. Cl. CPC F25B 9/10; F25D 19/006

(57) ABSTRACT

A cryogenic cooling system comprises a circuit (302, 501, 601) configured to convey operating fluid to and from a first heat exchanger region (303) at which the circuit (302, 501, 601) has a thermal coupling to a working region (301). An inbound part (304, 502, 602) of said circuit (302, 501, 601) is before said first heat exchanger region (303) in the flowing direction of said operating fluid through the circuit (302, 501, 601). An outbound part (305, 503, 603) of said circuit (302, 501, 601) is after said first heat exchanger changer region (303) in the flowing direction of said operating fluid through the circuit (302, 501, 601). One or more active heat exchangers (401, 504, 505, 506) are coupled between said inbound part (304, 502, 602) and said outbound part (305, 503, 603) and configured to use input energy to transfer heat from the inbound part (304, 502, 602) to the outbound part (305, 503, 603) during operation.

### FIELD OF THE INVENTION

The invention is generally related to the cooling of cryostats. In particular, the invention is related to structural solutions and refrigeration mechanisms that enable cooling a cryostat efficiently, with reasonable consequences in structural complexity.

### BACKGROUND OF THE INVENTION

Early cryostats were cooled with baths of liquid cryogens, such as liquid nitrogen and liquid helium. Later, mechanical cooling devices such as Stirling cryocoolers, Gifford-McMahon coolers, Pulse Tube Refrigerators (PTRs), and Joule-Thomson coolers have been introduced to implement so-called cryogen-free cooling. If the core part of the cryostat comprises a further cooling system such as a dilution refrigerator, which only becomes operative at temperatures at and below about 4 K, the required pre-cooling may be made with for example a PTR. In a typical case, the PTR has two cooling stages, of which the first stage is used to achieve a temperature around 40K-70K and the second stage pre-cools the still of the dilution refrigerator to the required 3K-4K level.

A dilution refrigerator is a closed-circuit system in which the isotope composition of the operating fluid varies between different stages of the circuit. The two isotopes involved are 3He and 4He. In the mixing chamber a 3He-rich phase floats on top of a phase poorer in 3He. Constant pumping makes some of the 3He cross the phase boundary to the 3He-poor phase, and the heat necessary for this dilution is the useful cooling power at the base temperature. The so-called dilute channel leads from the mixing chamber to the still, from which the evaporating 3He is circulated back through compression and pre-cooling so that it eventually flows back to the mixing chamber.

There are also cryogenic cooling systems in which an operating fluid circulates in a closed circuit without any changes to its isotope composition. An example of such a cooling system is a so-called siphon probe that can be used to insert samples into a cryogenically cooled environment. Cold operating fluid such as liquid helium may be circulated through an ingoing capillary tube down the probe to its end where a sample holder has been attached. The cold operating fluid absorbs heat from the sample holder, after which the heated (and at least partially vaporized) operating fluid is collected through a return tube in the probe. Corresponding fluid-circulating arrangements can also be used in cryostats where no sample changer mechanism is provided but the circulated operating fluid cools just the working region or some other fixed part of the cryostat.

Essential merits of the performance of any cryogenic cooling system include the lowest base temperature that can be achieved and the cooling power available at each temperature level. In cryogenic cooling systems based on a closed circuit, achieving best performance at the working region or lowest temperature level would require reducing the enthalpy of the operating fluid as much as possible before it reaches that part of the circuit where it begins to absorb heat from the parts to be cooled at the working region.

### SUMMARY

It is an objective to present a cryogenic cooling system and a cooling method that offer a reasonable balance between achievable base temperature and cooling power. Another objective is to combine effective cooling with only a reasonable increase in structural complicatedness.

These and further advantageous objectives are achieved by utilising one or more active heat exchangers in combination with the circuitry in which operating fluid is circulated for cooling.

According to a first aspect, there is provided a cryogenic cooling system for cooling a working region. The cryogenic cooling system comprises a circuit configured to convey operating fluid to and from a first heat exchanger region at which the circuit has a thermal coupling to said working region. The cryogenic cooling system comprises an inbound part of said circuit before said first heat exchanger region in the flowing direction of said operating fluid through the circuit and an outbound part of said circuit after said first heat exchanger region in the flowing direction of said operating fluid through the circuit. The cryogenic cooling system comprises one or more active heat exchangers coupled between said inbound part and said outbound part and configured to use input energy to transfer heat from the inbound part to the outbound part during operation.

According to an embodiment, the cryogenic cooling system is configured to maintain an isotopic composition of said operating fluid constant throughout the circuit. This involves at least the advantage that also relatively simple and robust cooling systems may benefit from the advantageous features of the invention.

According to an embodiment, the cryogenic cooling system is configured to control the flow characteristics of said operating fluid such that the specific heat capacity of operating fluid at a portion of the outbound part to which an active heat exchanger among said one or more active heat exchangers transfers heat is larger than the specific heat capacity of operating fluid at a portion of the inbound part from which said active heat exchanger transfers said heat. This involves at least the advantage that the active heat exchanger can be made to operate at relatively high efficiency.

According to an embodiment, among said at least one active heat exchangers is at least one of a solid-state microrefrigerator based on normal metal—insulator—superconductor tunnel junctions, referred to as a NIS refrigerator below; a solid-state microrefrigerator based on superconductor—insulator—normal metal—insulator—super-conductor tunnel junctions, referred to as a SINIS refrigerator below; or a solid-state microrefrigerator based on semiconductor—superconductor tunnel junctions, referred to as an Sm-S refrigerator below. This involves at least the advantage that the sophisticated characteristics and relatively high efficiency at extremely low temperatures of these types of refrigerators can be used.

According to an embodiment, among said at least one active heat exchangers is at least one NIS refrigerator or SINIS refrigerator that comprises, in the following order from a first end of the NIS refrigerator or SINIS refrigerator to a second end of the NIS refrigerator or SINIS refrigerator: a first contact electrode layer for biasing; an electrically conductive or semiconductive substrate layer; a layer of normal metal—insulator—super-conductor tunnel junctions or superconductor—insulator—normal metal—insulator—superconductor tunnel junctions; a superconductor layer, and a second contact electrode layer for biasing. This involves at least the advantage that the refrigerator can be coupled to the circuit in an organized and efficient manner.

According to an embodiment, said superconductor layer comprises constrictions for limiting the propagation of phonons from the superconductor layer to the layer of normal metal—insulator—superconductor tunnel junctions or superconductor—insulator—normal metal—insulator—superconductor tunnel junctions. This involves at least the advantage that efficiency of the refrigerator can be improved.

According to an embodiment, among said at least one active heat exchangers is a solid-state microrefrigerator based on the use of electrons in a standard transistor structure as a gas-equivalent refrigerant that is alternately expanded and compressed in a Carnot cycle to induce cooling. This involves at least the advantage that the sophisticated characteristics and relatively high efficiency at extremely low temperatures of these types of refrigerators can be used.

According to an embodiment, among said at least one active heat exchangers is an electrocaloric cooler. This involves at least the advantage that the sophisticated characteristics and relatively high efficiency at extremely low temperatures of these types of refrigerators can be used.

According to an embodiment, the cryogenic cooling system comprises a set of active heat exchangers. Each active heat exchanger in said set may then be coupled between said inbound part and said outbound part and configured to use input energy to transfer heat from the inbound part to the outbound part during operation. At least two active heat exchangers in said set may be NIS refrigerators and may have the superconductor part of their normal metal—insulator—superconductor tunnel junctions made of superconductors of different transition temperatures. Said at least two NIS refrigerators may then be arranged along said circuit in an order of increasing distance from said first heat exchanger region, said order being also an order of increase in said transition temperatures. This involves at least the advantage that the best performance of refrigerators based on different superconductor materials can be utilized in an optimal way.

According to an embodiment, the cryogenic cooling system comprises a further active heat exchanger coupled between a first portion of said outbound part and a second portion of said outbound part, of which said second portion is further away along said outbound part from said first heat exchanger region than said first portion. Said further active heat exchanger may then be configured to use input energy to transfer heat from said first portion to the second portion during operation. This involves at least the advantage that the coldest parts of the system may be made to reach even lower temperatures.

According to an embodiment, the cryogenic cooling system comprises one or more first heat couplers coupling a respective end of the respective active heat exchanger to a respective portion of operating fluid in the respective part of the circuit. This involves at least the advantage that an optimal thermal coupling between the operating fluid and the active heat exchangers can be ensured.

According to an embodiment, the cryogenic cooling system comprises one or more flow impedances along the inbound part. This involves at least the advantage that the phase properties and enthalpy of the operating fluid flowing in the inbound part can be affected.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a refrigeration cycle,

FIG. 2 illustrates a refrigeration cycle augmented with active heat transfer,

FIG. 3 illustrates a cryogenic cooling system,

FIG. 4 illustrates a cryogenic cooling system,

FIG. 5 illustrates a cryogenic cooling system, and

FIG. 6 illustrates a cryogenic cooling system.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

FIG. 1 illustrates some thermodynamic aspects of a cryogenic cooling system for cooling a working region. A circuit is configured to convey operating fluid to and from the working region, which in FIG. 1 is represented by the lowest part of the drawing. An inbound part of the circuit is on the left in FIG. 1, where the flowing direction of operating fluid through the circuit is downwards, towards the working region. An outbound part of the circuit is on the right in FIG. 1, where the flowing direction of operating fluid through the circuit is upwards, out of the working region.

At the working region there is some kind of a load that is to be cooled. Heat from the load causes evaporation 101 of the operating fluid at or close to the working region. The region where heat from the load becomes absorbed in the operating fluid may be called a (first) heat exchanger region. The escaping vapour carries the heat extracted from the load as a part of its enthalpy. At a suitable other part of the system, the vapour is compressed 102 and then condensed 103 into liquid, during which part of the cycle it releases heat into the surroundings. In liquid form, the operating fluid is circulated to expansion 104, which causes partial evaporation and auto-refrigeration. The cooled mixture of liquid and vapour is circulated back towards the working region, where the cycle starts anew.

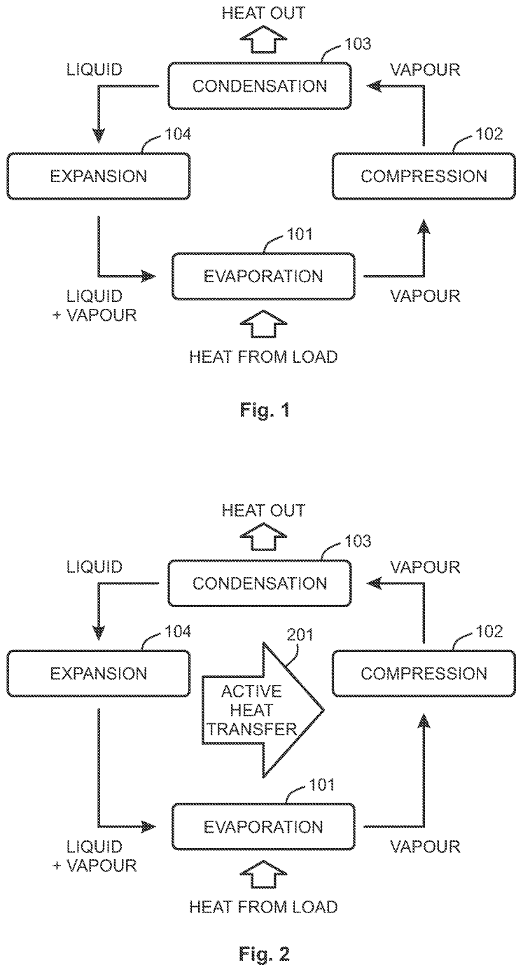

Basically, a cycle like that in FIG. 1 cools the working region (and the load therein) the more efficiently the larger the increase of enthalpy of the operating fluid can be made as it passes through the (first) heat exchanger region at or close to the working region. FIG. 2 illustrates a principle that can be followed to make the cooling of the working region more efficient. According to the principle shown in FIG. 2, one or more active heat exchangers can be coupled between the inbound part and the outbound part of the circuit, causing an effect shown as active heat transfer 201 in FIG. 2.

Contrary to passive heat exchangers, which rely simply on the second law of thermodynamics, allowing two entities of different temperature to inherently seek thermal equilibrium, an active heat exchanger is a device that uses input energy to transfer heat from its first end to its second end during operation. In this definition, input energy means some form of energy other than what is carried in as a part of the enthalpy of a substance to be cooled at said first end. In electrically operated active heat exchangers, the input energy is the electric energy flowing through the electric circuit where the active heat exchanger forms a part so that it receives operating power from an external voltage or current source. Examples of active heat exchanger types that may be used in the way shown in FIG. 4 are described in more detail later in this text.

FIG. 2 shows how the one or more active heat exchangers coupled between the inbound part and the outbound part of the circuit (meaning the circuit configured to convey operating fluid) are configured to use input energy to transfer heat from the inbound part to the outbound part during operation. As this increases the difference in enthalpy between that portion of operating fluid that is flowing towards the working region and that portion of operating fluid that is flowing out of the working region, the working region is cooled more efficiently than in FIG. 1.

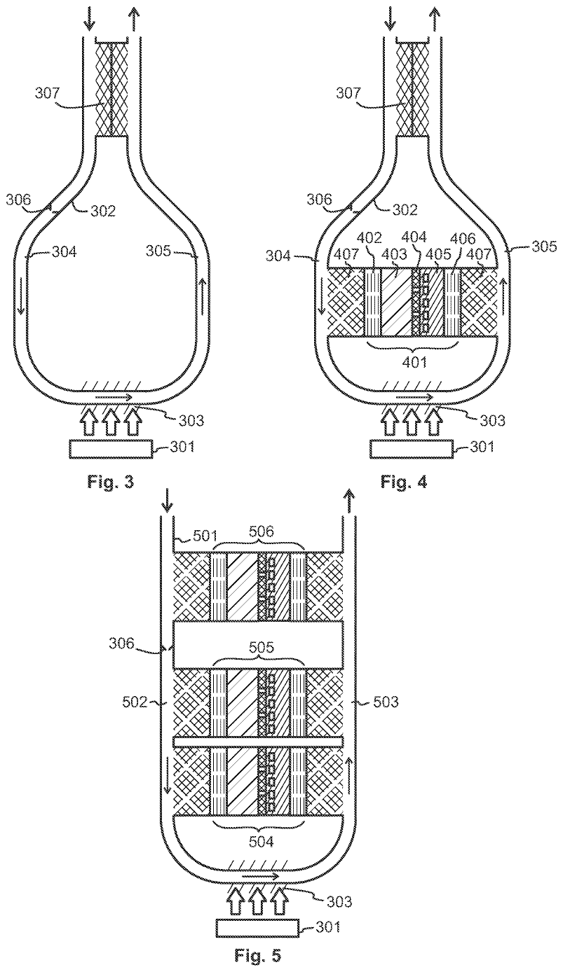

FIGS. 3 and 4 show two cryogenic cooling systems that illustrate the principal difference between FIGS. 1 and 2 in practice. Both cryogenic cooling systems are there to cool a working region 301. A circuit 302 is configured to convey operating fluid (such as nitrogen, helium, hydrogen, a mixture of these, or some other cryogenic cooling fluid) to and from a first heat exchanger region 303 at which the circuit 302 has a thermal coupling to the working region 301. An inbound part 304 of the circuit is on the left in both systems, located before the first exchanger region 303 in the flowing direction of the operating fluid through the circuit 302. An outbound part 305 is on the right in both systems, located after the first heat exchanger region 303 in the flowing direction of the operating fluid through the circuit 302. A flow impedance 306, built in the form of a throttle valve for example, may be located at some point of the inbound part 304 to cause the expansion of the operating fluid that was shown with reference designator 104 in FIGS. 1 and 2. Also shown is a second heat exchanger region 307 at which a passive heat exchanger is provided between the inbound part 304 and the outbound part 305 of the circuit. The purpose of a passive heat exchanger, if provided, is to transfer heat from the incoming operating fluid to the outgoing operating fluid, i.e. to cool the incoming operating fluid before it enters the first heat exchanger region 303.

The cryogenic cooling system of FIG. 4 comprises an active heat exchanger 401 coupled between the inbound part 304 and the outbound part 305 of the circuit. The active heat exchanger 401 is configured to use input energy (not separately shown in FIG. 4) to transfer heat from the inbound part 304 to the outbound part 305 during operation.

With reference to the definition of an active heat exchanger above, the first end of the active heat exchanger 401 is its left end the second end is its right end in FIG. 4. As the second end is thermally coupled to the outbound flow of operating fluid, the operating fluid acts as a vehicle for transporting away the heat that the active heat exchanger extracted from the inbound flow of operating fluid.

One possible form of an active heat exchanger 401 is a solid-state microrefrigerator based on the use of electrons in a standard transistor structure as a gas-equivalent refrigerant that is alternately expanded and compressed in a Carnot cycle to induce cooling. Such an active heat exchanger is known for example from a patent publication US20220208644A1, which is incorporated herein by reference.

Another possible form of an active heat exchanger 401 is an electrocaloric cooler. Such an active heat exchanger is known for example from a scientific publication Adriana Greco, Claudia Masselli: “Electrocaloric Cooling: A Review of the Thermodynamic Cycles, Materials, Models, and Devices”, Magnetochemistry 2020, 6, 67; doi:10.3390/magnetochemistry 6040067, which is incorporated herein by reference.

Another possible form of an active heat exchanger 401 is a solid-state microrefrigerator based on normal metal—insulator—superconductor tunnel junctions, superconductor—insulator—normal metal—insulator—superconductor tunnel junctions, or semiconductor—superconductor tunnel junctions. Such active heat exchangers are frequently referred to as NIS refrigerators, SINIS refrigerators, or Sm-S refrigerators respectively. Examples of NIS refrigerators are known for example from a patent publication U.S. Pat. No. 6,581,387B1, which is incorporated herein by reference. Examples of Sm-S refrigerators are known for example from a scientific publication Emma Mykkänen et al: “Thermionic junction devices utilizing phonon blocking”, Sci. Adv. 2020; 6: eaax9191 10 Apr. 2020, which is incorporated herein by reference.

Assuming that the active heat exchanger 401 is a NIS refrigerator, it may have a layered structure as schematically shown in FIG. 4. A first contact electrode layer 402, made of gold, copper, or other material that is both thermally and electrically highly conductive, is provided at the first end of the NIS refrigerator for biasing the NIS refrigerator. Towards the right from the first contact electrode layer 402 in FIG. 4 are an electrically conductive or semiconductive substate layer 403, which may be made of metal or crystalline silicon for example, and a layer 404 of normal metal—insulator—superconductor tunnel junctions. In case of a SINIS refrigerator, the layer 404 comprises superconductor—insulator—normal metal—insulator—superconductor tunnel junctions.

Further towards the right are a superconductor layer 405 as well as a second contact electrode layer 406 for biasing. Similar to the first contact electrode layer 402, the second contact electrode layer 406 is made of gold, copper, or other material that is both thermally and electrically highly conductive. A bias voltage between the first and second contact electrode layers 402 and 406 generates the electric field across the NIS refrigerator that is needed for its proper operation. In addition to said biasing, the second contact electrode layer 406 acts as a quasi-particle trap, for which purpose it is advantageous to place it close to the tunnel junctions.

The operating principle of a NIS (or SINIS, or Sm-S) refrigerator is based on tunnelling. The bias voltage across the NIS refrigerator is set so that only the most energetic, i.e. hottest, electrons may tunnel through the thin insulator layer to the superconductor, lowering the mean electron temperature in the normal metal. The transferred thermal energy may leak back in the opposite direction in the form of phonons, particularly if the overall temperature is too high. However, by keeping the overall temperature low enough and by using certain specific structural solutions, the undesired leakage backwards of thermal energy may be kept under control.

As an example of specific structural solutions, the superconductor layer 405 in FIG. 4 may comprise constrictions for limiting the propagation of phonons from the superconductor layer 405 to the layer 404 of normal metal—insulator—superconductor tunnel junctions (or superconductor—insulator—normal metal—insulator—superconductor tunnel junctions). The constrictions may be made by any known means, for example by patterning the region close to the tunnel junction and by using there suitable materials of varying acoustic impedance. This aims at blocking phonon-based heat transport by reflecting phonons. The reflecting may be emphasized by using meta-materials, meaning layered substances made by atomic layer deposition, in which two or more materials alternate in layers of atom-scale thickness. Photolithographic methods are also available for patterning of said kind.

Structural solutions in the NIS-, SINIS-, or Sm-S refrigerator may also comprise one or more of those disclosed in the document US20220272869A1, which is incorporated herein by reference.

The efficiency of cooling that may be achieved with a NIS, SINIS, or Sm-S refrigerator depends, among others, on the superconductor selected for the “S” side of the tunnel junction(s). It is known that the general temperature level at which the NIS, SINIS, or Sm-S refrigerator should operate should be below, and have an appropriate relation to, the critical temperature of the selected superconductor. As a rough guideline, it may be advantageous to select the critical temperature of the superconductor at a level of about twice the assumed temperature of the warmer end of the NIS, SINIS, or Sm-S refrigerator during operation.

In general, a drawback of NIS, SINIS, or Sm-S refrigerators has been the relatively small temperature difference that can be achieved between its ends. Trying to increase the temperature difference results in a larger and larger proportion of the transferred heat leaking back through the junctions through phononic conduction. Additionally, as indicated above, a NIS, SINIS, or Sm-S refrigerator may have a relatively narrow temperature range in which it operates efficiently, depending on the materials selected. Attempts have been made to circumvent these drawbacks by stacking two or more NIS, SINIS, or Sm-S refrigerators on top of each other and selecting their materials so that the refrigerator closest to the cold end of the stack would have its materials optimized for the lowest temperatures, the next refrigerator in the stack would have its materials optimized for slightly higher temperatures, and so on. However, it must also be noted that the coefficient of efficiency of a NIS, SINIS, or Sm-S refrigerator may be somewhat low, in the order of 25%. In a stacked configuration, each refrigerator towards the warmer end of the stack must transfer not only the original thermal energy extracted from what was to be cooled at the cold end but also the waste heat introduced by the refrigerators preceding it in the stack. Essentially, the coefficient of efficiency of a series of NIS, SINIS, or Sm-S refrigerators is the product of the coefficients of efficiency of all individual refrigerators in the series. For this reason, it is considered more advantageous to have only a single NIS, SINIS, or Sm-S refrigerator, or at most two in series, at the location shown with reference designator 401 in FIG. 4. In other words, it is advantageous to use a refrigerator of said kind in which the thermal energy that is transferred across will only pass through a single layer or at most two layers of those junction structures that make a NIS, SINIS, or Sm-S refrigerator respectively.

Heat couplers 407 are provided for thermally coupling the first and second ends of the active heat exchanger 401 to the portions of circulated operating fluid flowing through the inbound part 304 and outbound part 305 respectively. Volumes of sintered thermal conductor material are frequently used as the means for providing an effective thermal coupling between an operating fluid and a piece of solid material in cryogenic cooling systems. Thus, also here, at least one of the heat couplers 407 may comprise a volume of sintered thermal conductor material in a space that forms a part of the respective part of the circuit. The use of sintered thermal conductor material is based on the fact that in sintered form, the material provides a relatively large overall contact surface at which heat may flow between the operating fluid and the solid material. Simultaneously, thermal conduction paths through the sintered material allow heat to flow between the volume of sintered material and the solid surface to which it is attached.

Additionally or alternatively, at least one of the heat couplers 407 may comprise a structured internal surface made of a thermal conductor material on one or more walls of a space that forms a part of the inbound or outbound part respectively. Said structured internal surface may have been formed by an additive manufacturing process and may comprise a plurality of extended thermal conduction paths in the form of regularly shaped portions of the thermal conductor material that extend through a majority of a structured thickness of said internal surface. The purpose is the same as with sintered material, i.e. to offer both a large overall heat transfer surface to the operating fluid and to simultaneously provide thermal conduction paths to the solid surface beneath. Structured internal surfaces of this kind are known for example from the patent publication EP3910276, which is incorporated herein by reference.

The cryogenic cooling system represented by the schematical illustration in FIG. 4 may be one that is configured to maintain an isotopic composition of the operating fluid constant throughout the circuit. This is a difference to systems in which the inbound flow of operating fluid consists of essentially pure 3He pumped to the mixing chamber of a dilution refrigerator and the outbound flow of operating fluid would be a part of the respective circuit between the mixing chamber and the still of the dilution refrigerator (or the line continuing further from the still towards the room temperature parts of the circuit). In a simple embodiment, the circuit in FIG. 4 is a closed circuit in which the operating fluid is just made to flow without any intermediate changes of significance to its isotopic composition.

It is advantageous, though, if the cryogenic cooling system is configured to control the flow characteristics of operating fluid such that the specific heat capacity of operating fluid at the portion of the outbound part 305 (the part to which the active heat exchanger 401 transfers heat) is larger than the specific heat capacity of operating fluid at the portion of the inbound part 304 from which said active heat exchanger transfers said heat. This can be accomplished for example so that compared to the inbound part 304, the operating fluid flowing in the outbound part 305 is in gaseous form to a larger relative extent, and at a lower pressure. The relative proportions of liquid and gaseous phase in the inbound part 304 may be controlled by controlling the rate at which operating fluid is pumped thereto, as well as by selecting the location and dimensioning of one or more flow impedances 306 along the inbound part 304. It is not obligatory to have even a single flow impedance in the inbound part of the circuit if the conditions for the flow of operating fluid can be made right otherwise. The relative extent to which the operating fluid is in gaseous form in the outbound part 305 is affected, in addition to the factors listed above, by the relation between the circulation rate of the operating fluid and the heat load from the working region 301.

FIG. 5 shows a principle that may be used to increase the efficiency of actively transferring heat from the inbound part to the outbound part of a circuit 501. In the embodiment of FIG. 5, the cryogenic cooling system comprises a set of active heat exchangers 504, 505, and 506. Each active heat exchanger in the set is coupled between the inbound part 502 and the outbound part 503 of the circuit 501. Being active heat exchangers, each active heat exchanger in the set is configured to use input energy (other than that coming in along with the operating fluid) to transfer heat from the inbound part 502 to the outbound part 503 during operation.

At least two of the active heat exchangers 504, 505, and 506 are NIS, SINIS, or Sm-S refrigerators and have the superconductor part of their tunnel junctions made of superconductors of different transition temperatures. Such at least to NIS, SINIS, or Sm-S refrigerators are arranged along the circuit 501 in an order of increasing distance from the (first) heat exchanger region so that the same order is also an order of increase in said transition temperatures.

An arrangement like that in FIG. 5 solves the problems of narrow optimal temperature ranges, relatively small temperature difference across the tunneling junction, and relatively low efficiency that were mentioned above with reference to the attempted stacked configurations of NIS, SINIS, or Sm-S refrigerators. In an arrangement like that of FIG. 5. the temperature of the operating fluid in both the inbound part 502 and the outbound part 503 is the higher the further away one is from the working region 301 (or, more exactly, from the heat exchanger region 303). Assuming that this increase in temperature as a function of increasing distance is approximately equally steep in both parts, the temperature difference across the ends of each individual active heat exchanger 504, 505, and 506 may remain sufficiently small for efficient operation. And as on each level the heat needs to be transferred through only a single NIS, SINIS, or Sn-S refrigerator (i.e. a single layer junction of structures), the coefficient of efficiency can remain relatively high in each case.

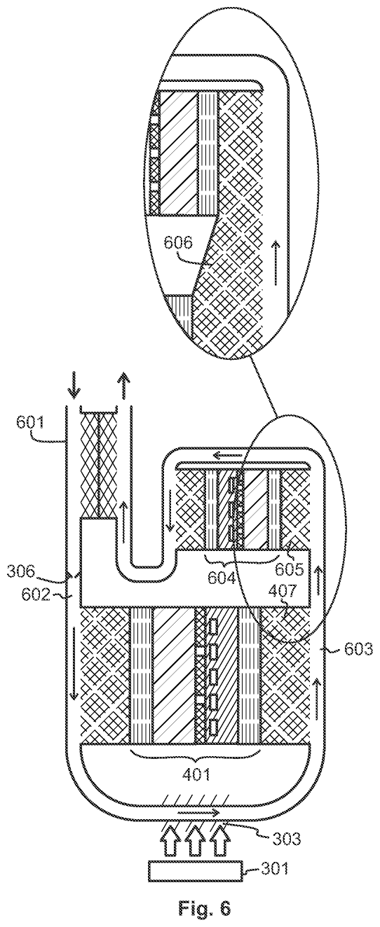

FIG. 6 illustrates a further possible way of using an active heat exchanger along a circuit 601 configured to convey operating fluid to and from a heat exchanger region 303 at which the circuit 601 has a thermal coupling to a working region 301. The inbound and outbound parts of the circuit are shown with reference designators 602 and 603 respectively. In the embodiment of FIG. 6, the cryogenic cooling system comprises a further active heat exchanger 604 coupled between a first portion of the outbound part 603 and a second portion of the outbound part 603. Of these, said second portion is further away along said outbound part 603 from the heat exchanger region 303 than said first portion. As the definition indicates, the further active heat exchanger 604 is configured to use input energy to transfer heat from said first portion to the second portion during operation.

The idea in the use of a further active heat exchanger like in FIG. 6 is to actively transfer some heat even further along the outbound part, which should lower the temperature of the operating fluid in the outbound part closer to the working region. This may then improve the possibility of the active heat exchanger closest to the working region (reference designator 401 in FIG. 6) to lower the enthalpy of the operating fluid in the inbound part of the circuit as low as possible, which in turn may help to cool the working region 301 as cold as possible.

The partial enlargement in the top part of FIG. 6 shows a possible modification to the main principle shown in the lower part. As the second end of the lower active heat exchanger 401 and the first end of the upper active heat exchanger 604 are essentially at the same temperature anyway, instead of having separate heat couplers 407 and 605 for each them one could have a common heat coupler 606 along the outbound part 603 of the circuit 601 for thermally coupling both the second end of the lower active heat exchanger 401 and the first end of the upper active heat exchanger 604 to the operating fluid flowing in the outbound part 603. In addition to or in place of a common heat coupler 606, other means may be employed to ensure good conduction of heat between the parts that are shown with reference designators 407 and 605 in the main part of the drawing. Examples of such other means include but are not limited to heat transferring liquid on the walls of this part of the circuit; a heat transfer pipe; and a solid thermal conductor. Even the operating fluid that flows in the outbound part of the circuit may constitute some kind of thermal conductor for providing a thermally conductive connection between the parts 407 and 605.

It is obvious to a person skilled in the art that with the advancement of technology, the basic idea of the invention may be implemented in various ways. The invention and its embodiments are thus not limited to the examples described above, instead they may vary within the scope of the claims.

1. A cryogenic cooling system for cooling a working region (301), comprising:
a circuit (302, 501, 601) configured to convey operating fluid to and from a first heat exchanger region (303) at which the circuit (302, 501, 601) has a thermal coupling to said working region (301);
an inbound part (304, 502, 602) of said circuit (302, 501, 601) before said first heat exchanger region (303) in the flowing direction of said operating fluid through the circuit (302, 501, 601);
an outbound part (305, 503, 603) of said circuit (302, 501, 601) after said first heat exchanger region (303) in the flowing direction of said operating fluid through the circuit (302, 501, 601); and
one or more active heat exchangers (401, 504, 505, 506) coupled between said inbound part (304, 502, 602) and said outbound part (305, 503, 603) and configured to use input energy to transfer heat from the inbound part (304, 502, 602) to the outbound part (305, 503, 603) during operation.

2. A cryogenic cooling system according to claim 1, wherein the cryogenic cooling system is configured to maintain an isotopic composition of said operating fluid constant throughout the circuit (302, 501, 601).

3. A cryogenic cooling system according to claim 1, wherein the cryogenic cooling system is configured to control the flow characteristics of said operating fluid such that the specific heat capacity of operating fluid at a portion of the outbound part (305, 503, 603) to which an active heat exchanger among said one or more active heat exchangers transfers heat is larger than the specific heat capacity of operating fluid at a portion of the inbound part (304, 502, 602) from which said active heat exchanger transfers said heat.

4. A cryogenic cooling system according to claim 1, wherein among said at least one active heat exchangers (401, 504, 505, 506) is at least one of a solid-state microrefrigerator based on normal metal—insulator—superconductor tunnel junctions, a solid-state microrefrigerator based on superconductor—insulator—normal metal—insulator—superconductor tunnel junctions, and a solid-state microrefrigerator based on semiconductor—superconductor tunnel junctions.

5. A cryogenic cooling system according to claim 3, wherein among said at least one active heat exchangers (401, 504, 505, 506) is at least one solid-state microrefrigerator based on normal metal—insulator—superconductor tunnel junctions or solid-state microrefrigerator based on superconductor—insulator—normal metal—insulator—superconductor tunnel junctions that comprises, in the following order from a first end to a second end, a first contact electrode layer (402) for biasing, an electrically conductive or semiconductive substrate layer (403), a layer (404) of normal metal—insulator—superconductor tunnel junctions or superconductor—insulator—normal metal—insulator—superconductor tunnel junctions, a superconductor layer (405), and a second contact electrode layer (406) for biasing.

6. A cryogenic cooling system according to claim 4, wherein said superconductor layer (405) comprises constrictions for limiting the propagation of phonons from the superconductor layer (405) to the layer (404) of normal metal—insulator—superconductor tunnel junctions or superconductor—insulator—normal metal—insulator—superconductor tunnel junctions.

7. A cryogenic cooling system according to claim 1, wherein among said at least one active heat exchangers (401, 504, 505, 506) is a solid-state microrefrigerator based on the use of electrons in a standard transistor structure as a gas-equivalent refrigerant that is alternately expanded and compressed in a Carnot cycle to induce cooling.

8. A cryogenic cooling system according to claim 1, wherein among said at least one active heat exchangers (401, 504, 505, 506) is an electrocaloric cooler.

9. A cryogenic cooling system according to claim 1, wherein the cryogenic cooling system comprises a set of active heat exchangers (504, 505, 506), each active heat exchanger in said set (504, 505, 506) is coupled between said inbound part (502) and said outbound part (503) and configured to use input energy to transfer heat from the inbound part (502) to the outbound part (503) during operation, at least two active heat exchangers in said set (504, 505, 506) are NIS refrigerators and have the superconductor part of their normal metal—insulator—superconductor tunnel junctions made of superconductors of different transition temperatures, and said at least two NIS refrigerators are arranged along said circuit (501) in an order of increasing distance from said first heat exchanger region (303), said order being also an order of increase in said transition temperatures.

10. A cryogenic cooling system according to claim 1, wherein the cryogenic cooling system comprises a further active heat exchanger (604) coupled between a first portion of said outbound part (603) and a second portion of said outbound part (603), of which said second portion is further away along said outbound part (603) from said first heat exchanger region (303) than said first portion, and said further active heat exchanger (604) is configured to use input energy to transfer heat from said first portion to the second portion during operation.

11. A cryogenic cooling system according to claim 1, comprising one or more first heat couplers (407) coupling a respective end of the respective active heat exchanger (401, 504, 505, 506, 604) to a respective portion of operating fluid in the respective part of the circuit.

12. A cryogenic cooling system according to claim 1, comprising one or more flow impedances (306) along the inbound part (304, 502, 602).
